(19) United States
(12) Patent Application Publication
(10) Pub. No.: US 2014/0207604 A1
(43) Pub. Date: Jul. 24, 2014

(54) WEB-BASED TECHNIQUE FOR DYNAMIC COMPETITIVE PRICING

(71) Applicant: INTERNATIONAL BUSINESS MACHINES CORPORATION, Armonk, NY (US)

(72) Inventor: Edward T. Morgan, Issaquah, WA (US)

(73) Assignee: INTERNATIONAL BUSINESS MACHINES CORPORATION, Armonk, NY (US)

(21) Appl. No.: 13/746,454

(22) Filed: Jan. 22, 2013

(51) Int. Cl. G06Q 30/06

(52) U.S. Cl. CPC G06Q 30/0611
USPC 705/26.4

(57) ABSTRACT

Embodiments relate to a method, system and program product relating to dynamic competitive pricing. An aspect includes a method for providing digital auctions that uses a network manager to establish processing communication to at least one vendor participants. The network manager receives information about a consumer's contemplated purchase through a consumer's digital device. The information includes conditions related to the contemplated purchase. The information and conditions about the contemplated purchase of the consumer is then communicated, via the network manager, to the vendor participants. The network manager communicates back to the consumer a most advantageous offer provided by the vendor participants relating to the contemplated purchase through a webpage provided by the network manager.

### BACKGROUND

The present disclosure relates generally to competitive pricing and more particularly to a web-based technique for dynamic competitive pricing.

For centuries buyers have been searching for ways to purchase goods and services from merchants at lowest possible price. Traditionally, this entailed a combination of factors including locating the desired merchants who offer identical goods, researching for deals and coupons, and bargaining with each merchant in an effort to complete a competitive transaction. Similarly, merchants have been in search of finding purchasers for their goods and services at the highest price that the marketplace can support. An important aspect of completing such transactions, both for the merchants and their purchasers, is to be able to locate one another. Another aspect is to gain a competitive edge over their competitors by offering the best deal possible to one another without having to decrease or increase their price unnecessarily. In the past a variety of different techniques have been used to accomplish such a task. Public and private auctions, coupons and advertising schemes, and matching or lowering a competitor's offer upon presentation of competitor's advertisement have been among such techniques.

Digital technology has improved the manner that goods and services can be provided in the marketplace at the most advantageous price. Online auctioning has gained popularity in recent years. In fact, the scope and reach of on-line auctions have been propelled by the advent of digital technology to a level beyond what the initial purveyors had anticipated. This is mainly because online auctions remove the physical barriers and limitations of traditional auctions. On-line auctions reach a much larger target audience by removing limitations of geography, presence, time, and space.

### BRIEF SUMMARY

Embodiments include a method, system, and computer program product for providing digital auctions. The method includes establishing processing communication between a network manager and a plurality of vendor participants through a vendor's webpage. The network manager receives information about a consumer's contemplated purchase through a consumer's digital device including conditions related to the contemplated purchase. This information about the contemplated purchase is then communicated via the network manager to the plurality of vendor participants through the vendors' webpages. The network manager processes any more advantageous offers provided by any of the plurality of vendors through the vendors' websites in response to the consumer's contemplated purchase and providing a most advantageous offer through a network manager webpage to the consumer. A time threshold acceptance time is then established having an expiration period. The time threshold expiration time starts at a time when the most advantageous offer is communicated to the consumer and upon its expiration the most advantageous offer is automatically from the network manager's webpage. Alternatively upon acceptance of the offer, the most advantageous is also removed from the network manager's website.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the disclosure are apparent from the following detailed description taken in conjunction with the accompanying drawings in which:

FIG. 1 illustrates a flowchart in accordance with an embodiment; and

FIG. 2 illustrates a bock diagram depicting a network in accordance with an embodiment.

### DETAILED DESCRIPTION

Shopping comparisons can be made in a variety of different ways. In an ordinary auction (also known as a forward auction), buyers compete to obtain a good or service by offering increasingly higher prices. Bids can remain open or alternately follow a more traditional auction format which keep each bid as confidential. Eventually, one clear winner is defined after the auction finishes. In contrast, a reverse auction is a type of auction in which the roles of buyer and seller are reversed. In a reverse auction, the sellers compete to obtain business from the buyer and prices will typically decrease as the sellers undercut each other. Digital devices and networks and websites can provide similar opportunities and provide the same types of auctions.

Other auction websites can conceivably allow vendors to put items up for sale and to sell them to the highest bidder. Similarly, consumers can request a competitive price for a particular good or service. Such sites will allow consumers to express an interest in buying a product and soliciting vendors. In either case, bids can be made publicly or made private within a network of subscribers. Nonetheless, such processes take on the order of days, as the potential vendors see the current best price offer and consider bidding a lower price.

Retailers and service providers can also potentially use dynamic pricing as inventory levels and other factors change and change the price or a particular good or service. For example, the price may be lower when inventory is high, but it may change as inventory suddenly starts to deplete.

Besides personal computers, with the advent of mobile device, shopping comparison engines can also be conceivably provide similar information to consumers on current prices of a particular item across many websites. Comparison shopping can even be possible by scanning a particular product in a retail store and searching to find more competitive pricing in nearby stores or directly on websites. It is also conceivable to have an application that for example can reside in an end user's browser or on a mobile device that enables that very same activity. In this manner, while the end user is viewing products on supported websites or in a store, the software (plug-in etc.) will automatically do a price comparison and alert the user, such as through a pop-up window, that the item can be purchased at a cheaper price elsewhere. However, such programs may require constant scanning of websites and other materials available from retail stores to provide or determine current offers on a multitude of products. This materials and information then need to be stored at cost in a memory module and updated regularly.

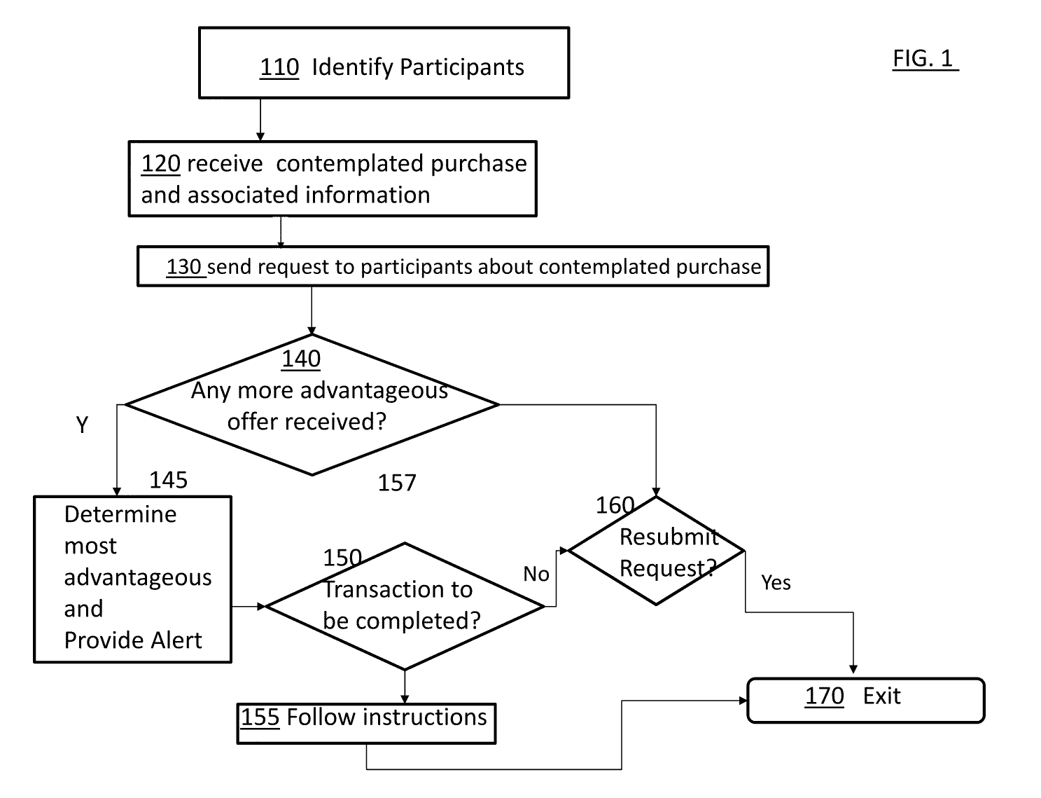

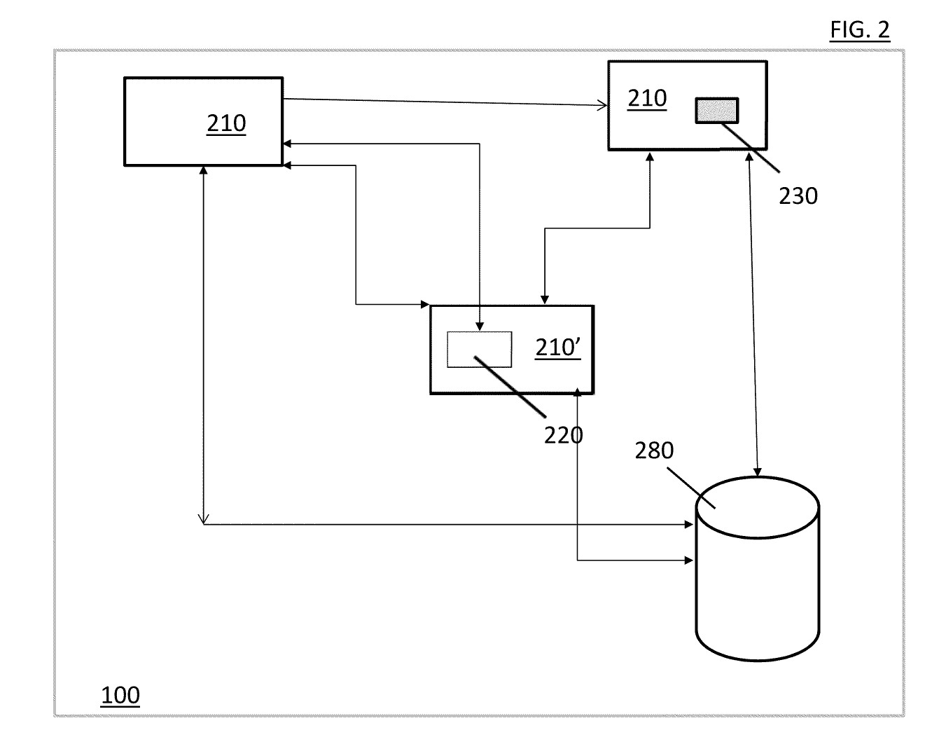

FIG. 1 provides a flowchart illustration as per one embodiment of the present invention. In block 110 a network of participants are identified, in one embodiment, to a network manager (see FIG. 2 at 210′). The network manager can simply be a processor performing software instructions. The network manager is in processing communication with one or more memory location to retrieve or match identity of participants. In other embodiment, other alternate arrangements can be made as know by those skilled in the art. The specifics pertaining to the network's connectivity and components are discussed later in conjunction with FIG. 2.

In one embodiment, the participants can include only a network of merchants or service providers who have agreed to participate. These merchants and service providers will now be referenced as participants for ease of clarity. It should be noted that the participants can become a member of the network in a variety of ways ranging from applying for a paid subscription to simply agreeing to terms and conditions that make their final offers binding. An end user or purchaser or consumer (the terms are used interchangeably throughout) can also be deemed a participant in one embodiment and may require similar agreements. In other embodiments, any consumer can interact via the network manager and no additional terms are required for such consumer until the time of completing the transaction.

As provided in block 120, the consumer or purchaser will then have the opportunity to participate in comparison shopping by providing information about a contemplated to be purchased good or service. The request by the consumer can be submitted in a number of ways as can be appreciated by those skilled in the art. For example, the consumer can actually submit the information by inputting the data through text or maybe by scanning the picture and information of the product via a mobile device while perusing a retail shop. In other embodiments, it can also be possible that the network manager actually approaches consumer by locating the consumer being interested in a purchase such as through locating interest on one more websites.

The information is then provided automatically to the network manager. This information can include a variety of conditions including price, type or model of the particular product, warranties offered and other components as can be appreciated by those skilled in the art. Once the network manager is provided with such information, in one embodiment, it will automatically then both comparison shop by browsing the product or services actively through the network and by providing it to the participants. In another embodiment, the conditions are provided through the network to participants, Once the price and information about the goods and services are provided to the network manager, the network manager would electronically or otherwise inform the participants about the possibility of a transaction as shown in block 130.

In this second embodiment, the network manager can have the option of forgoing the maintenance of a database with all goods and services current prices for every possible product and service. There is no need to then constantly have to scan many retailer websites to determine current price for each of their products. A network of merchants can be in this embodiment agree to participate to provide their goods and services instead as discussed.

A dynamic price calculation is then made based on whatever selective criteria is determined by either the participating merchants, (or alternatively if provided by the consumer purchaser). The participants then decides what the lowest price calculation would be based on such criteria in order to win the business and provide an offer in hopes that the transaction would be completed at block 140.

If such an offer is presented as provided in block 145, a message alert is then provided to the consumer. The message alert can be provided in a variety of manners such as a pop-up window on a computer screen, a text message on a mobile phone device or through other interactive manners including sounds and speech as can be appreciated by those skilled in the art. If the consumer purchaser will then decide to proceed with completing the transaction (block 150), the consumer is then provided with a series of instructions to complete the transaction as provided in block 155. These instructions can vary per participant (merchant) or transaction. The instruction, for example, may range from entering a secure website belonging to the participating merchant to simply clicking on a button on the screen of a device. Such methods can be varied as appreciate by those skilled in the art. Depending on the merchant's (participant) selection then more actions can also follow. For example, clicking on a pop-up button can automatically send money through a pre-paid site to the vendor who would then send the purchaser a receipt and other related information or as discussed the end user can then be guided through the participating merchant's website to complete the transaction by providing more private information such as a credit card followed by receipt and method of delivery options.

In one embodiment, for the consumer or end user purchaser to complete the transaction limitations may be set forth such as completing the transaction within a short fixed time. In such a case, the time can be determined selectively, for example by the service network or by each participant or even a group of participants. In another embodiment, other limitations may also be imposed. For example, the vendor or the purchaser may be obligated to sell/buy only one item at the stated price at a time.

It should be noted that if no participating merchant has offered the item or goods at a better price than submitted originally by the consumer purchaser, the consumer would not receive the price alert pop-up. However, in such a case or overall in all cases the process can be reiterative and new requests can be submitted in one embodiment as provided at block 160 (such as if the offer times out after the required limit elapses). The consumer can also select to not complete the transaction in cases where the price had changed dynamically by for example a retailer providing a better deal. In this case, again the purchaser may want to resubmit the original request.

If no new submissions are made or if the purchase is then completed, the process can end in one embodiment of the present invention as shown in block 170.

In one embodiment, the network manager establishing processing communication with a plurality of vendor participants through the vendor participant's webpage(s). The network manager then receives information about a consumer's contemplated purchase through a consumer's digital device including conditions related to the contemplated purchase. This information about the contemplated purchase is then communicated via the network manager to the vendor participants through their webpages. The network manager then searches on the vendor participant website or receives in other ways, a more advantageous offer relating to the contemplated purchase. The network manger then polls the offers and selects a most advantageous offer that might have been received during a specific time. The network manager then sets up its own special webpage to communicate this most advantageous offer to the consumer. A time threshold acceptance time is then established having an expiration period. The time threshold expiration time starts at a time when the most advantageous offer is communicated to the consumer and upon its expiration the most advantageous offer is automatically from the network manager's webpage. Alternatively upon acceptance of the offer, the most advantageous is also removed from the network manager's website. The time threshold acceptance time, can be established in one embodiment through the use of a counter that commences its count when the most advantageous offer is first communicated to the consumer.

In one embodiment, the participating merchants may not know the identities of the other merchants and the pricing may not be made public. In addition, the auction process may be selectively determined to be completed within seconds as oppose to days. In this way, the participating merchants would simply give their best dynamically computed price on the item in order to make a sale right then to that particular consumer (purchaser/end user). If the consumer does not complete the purchase within the time allotted (window), then the offer may be rescinded or alternatively lowered.

In one embodiment, once the transaction is completed, the participants may be then provided additional information that the transaction was completed without or without revealing the identity of consumer or successful participant. The final transacted price and conditions too may be either revealed or remain confidential. The knowledge that a transaction was completed, however, can allow other participants to know that no additional offers need to be made to win or finalize this particular transaction.

An example can now be provided to add clarity to one embodiment of the present invention, with the understanding that other such examples can be provided, especially as relating to alternate embodiment, as appreciated by those skilled in the art.

Suppose a consumer is considering purchasing a particular product on Merchant.com website. The Merchant's price is $79.95. The network manager is a shopping service software that would behind the scenes, query the participating merchants to see if they would sell the exact same item for a lower price. If a lower price is provided, the consumer would be then alerted to complete the purchase. It should be noted that there is nothing that would stop the Merchant from being one of the participating merchants and being able to drop its price on the item sufficiently to keep the purchaser from going elsewhere. In that case Merchant has to simply have to match the lowest offered price rather than having to beat it to be considered to have “won” the auction. In this case, instead of the alert saying that the consumer could buy the product on another site at a lower price, in one embodiment, the alert may say that the Merchant is willing to sell this product to you at a new price of $74.95 if you complete the purchase within the next ten minutes and then direct the end user purchaser to then maybe “click here to buy this product now” or provide other instructions to complete the transaction.

Referring now to FIG. 2, a block diagram of the network is provided as per one embodiment. The network can provide access to a number of participants and establish processing communication also between one or more end users. As illustrated in FIG. 2, the system comprises a plurality of nodes 210 that are in processing communication with one another. Each node 210 can represent a variety of digital devices, such as but not limited to mobile devices, personal computers, servers or others such devices can include one or more processors 230. In addition, the nodes 210 can further include display, input/output interfaces, printers or other components as can be appreciated by those skilled in the art. Any of the nodes can also be designated as a network manager. In this example, node 210′ was designated as the network manager.

The network manager (node 210′) can be enabled to be used by different entities that can include one or more participants including both vendors and/or purchasers (consumers) each of which can be represented by nodes 210. In addition, the network manager 210′ can include one more processors 220.

The processing communication can be enabled through wired or wireless processing or other alternate means. In addition, the processing means through which the nodes 210 are in communication with one another are varied as can be appreciated by those skilled in the art. For example, in one embodiment, one or more nodes 210 can be in processing communication with one another using the Internet or world wide web but in other embodiments they can be part of a secured and privatized network. In one embodiment, each node 210 can also include internal memory as shown at 230, or be in processing communication with other node's internal memories, or in communication with one or more external memories such as the one shown in FIG. 2 at 280.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Further, as will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for providing digital auctions comprising:
establishing processing communication between a network manager and a plurality of vendor participants through a vendor's webpage;
said network manager, receiving information about a consumer's contemplated purchase through said consumer's digital device; said information including conditions related to said contemplated purchase;
communicating said information and conditions about said contemplated purchase of said consumer, via said network manager to said plurality of vendor participants through said vendors' webpages;
said network manager processing any more advantageous offers provided by any of said plurality of vendors through said vendors' webpage in response to said consumer's contemplated purchase;
providing a most advantageous offer through a network manager webpage; said network manager selecting a most advantageous offer by comparing all more advantageous offers provided within a specific time;
establishing a time threshold acceptance time having an expiration period, said time threshold expiration time starting at a time when said most advantageous offer is communicated to said consumer; and removing said most advantageous offer automatically from said network manager's webpage upon receiving a consumer acceptance of said most advantageous offer or upon reaching of said time threshold acceptance time expiration period.

2. The method of claim 1, wherein said consumer can resubmit new conditions relating to said contemplated purchase if no more advantageous conditions are communicated back to said consumer from said participants within a certain time.

3. The method of claim 1, wherein said consumer can resubmit other new conditions that will be then communicated to said participants.

4. The method of claim 1, wherein said consumer can resubmit another request for said same contemplated purchase after said time threshold acceptance time period expiration time has been reached.

5. The method of claim 1, wherein a plurality of consumers simultaneously communicate to said network manager regarding a plurality of contemplated purchases.

6. The method of claim 5, wherein said plurality of contemplated purchases relate to different categories of purchases.

7. The method of claim 5, wherein at least two of said contemplated purchases relate to same category of purchases and each of said two contemplated purchases are provided to said participants vendors separately.

8. The method of claim 1, wherein upon acceptance of said most advantageous offer, said network manager provides direct processing communication between said consumer and said participants vendor who has provided said most advantageous offer.

9. The method of claim 1, wherein upon acceptance of said most advantageous offer, said network manager provides options for said consumer to complete a purchasing transaction.

10. The method of claim 1, wherein said vendor participants can provide said network manager with a set of a set of instructions following to be provided to said consumer after acceptance of said most advantageous offer; said instructions including one or more methods of payment.

11. The method of claim 10, wherein said network manager provides said consumer a receipt relating to completing of said purchase transaction.

12. The method of claim 1, wherein said digital device used by said consumer is a mobile device.

13. The method of claim 1, wherein once an offer is accepted, said other vendor participants are informed of said consumer's acceptance.

14. The method of claim 13, wherein said other vendor participants are any of said vendor participants who had provided any of said more advantageous offers but who have not offered said most advantageous offer.

15. The method of claim 14, wherein no additional information is provided relating to acceptance terms of said offer.

16. The method of claim 14, wherein additional information is provided to acceptance term of said accepted offer to said other vendor participants.

17. A computer program product for transacting a sale, the computer program product comprising a computer readable storage medium having computer readable program code embodied therewith, said computer readable program code being executable by a processor to:
establish processing communication between a network manager and a plurality of vendor participants through a vendor's webpage;
receive, via said network manager, information about a consumer's contemplated purchase through a consumer's digital device; said information including conditions related to said contemplated purchase;
communicate said information and conditions about said contemplated purchase of said consumer, via said network manager to said plurality of vendor participants through said vendors' webpages;
process via said network manager any more advantageous offers provided by any of said plurality of vendors through said vendors' webpages in response to said consumer's contemplated purchase;
provide a most advantageous offer through a network manager webpage; said network manager selecting a most advantageous offer by comparing all more advantageous offers provided within a specific time;
establish a time threshold acceptance time having an expiration period; said time threshold expiration time starting at a time when said most advantageous offer is communicated to said consumer; and
remove said most advantageous offer automatically from said network manager's webpage upon said consumer accepting said most advantageous offer or upon reaching of said time threshold acceptance time expiration period.

18. The computer program product of claim 17, wherein said offer relates to sale of goods.

19. The computer program product of claim 17, wherein said offer relates to sale of services.

20. A system comprising:
a network manager having memory module for identifying a plurality of vendor participants and establishing processing communication with them via a plurality of vendor participants webpages;
said network manager having a processor configured for receiving information about a consumer's contemplated purchase via said consumer's mobile device; said information including conditions related to said contemplated purchase;
said network manager communicating said information and conditions about said contemplated purchase of said consumer to said plurality of vendor participants through said vendors' webpages;
said network manager processing any more advantageous offers provided by any of said plurality of vendors through said vendors' webpage in response to said consumer's contemplated purchase and providing a most advantageous offer through a network manager webpage to said consumer;
a time acceptance time counter with an expiration threshold; said counter starting its count upon said most advantageous offer;
said network manager being responsive to said expiration threshold such that once such threshold has been exceeded said network manager removes said most advantageous offer from its webpage.
